(19) United States
(12) Patent Application Publication
(10) Pub. No.: US 2024/0308032 A1
(43) Pub. Date: Sep. 19, 2024

(54) APPARATUS, SYSTEM, AND METHODS FOR FACILITATING ROTATION OF CONNECTOR FITTINGS

(71) Applicant: Jonas Adrian LaPointe, Williamsburg, MA (US)

(72) Inventor: Jonas Adrian LaPointe, Williamsburg, MA (US)

(21) Appl. No.: 18/598,370

(22) Filed: Mar. 7, 2024

Related U.S. Application Data
(60) Provisional application No. 63/453,110, filed on Mar. 19, 2023.

(51) Int. Cl. B25B 13/50

(52) U.S. Cl. CPC B25B 13/5091

(57) ABSTRACT

An apparatus for facilitating rotation of a fitting includes a body having an exterior portion and an interior portion, the exterior portion having an opening configured to allow the body to be placed onto the fitting such that the fitting is received in the interior portion. The body further includes a plurality of engagement surfaces, the plurality of engagement surfaces configured to matingly engage an exterior of the fitting. The body also includes at least two ergonomic tabs that are configured to be gripped by a user to facilitate rotation of the fitting and at least one stop located on the body, the at least one stop configured to inhibit axial movement of the body relative to the fitting when secured thereto. In use, the body may be selectively placed on a fitting to facilitate rotation of the fitting by a user.

### CROSS-REFERENCE TO RELATED APPLICATION

The present application claims the benefit of U.S. Provisional Patent Application Ser. No. 63/453,110 filed on Mar. 19, 2023, which is incorporated by reference in its entirely.

### BACKGROUND

### Technical Field

Embodiments of the invention relate generally to ergonomic aids, and, more particularly, to apparatus, systems, and methods that facilitate rotation of twisting connector fittings such as luer and coaxial connectors.

### Discussion of Art

Many rotatable/twistable connector devices, e.g. medical luer connectors and coaxial cable connectors, are relatively small and difficult to manipulate. This problem is particularly acute for users such as young children, aged persons, and persons having debilitating illnesses such as arthritis or the like. In certain settings, such as home dialysis, users with limited manual dexterity may have difficulty rotating/manipulating such connectors. As will be appreciated, in this context, these challenges are particularly undesirable as they can potentially lead to negative health outcomes.

While various gripping devices do exist, there are no known devices that may be easily attached and removed from a connector (e.g., attached or removed with one hand). There are also no known gripping devices that may be selectively removed from a connector while it is secured or attached to tubing, another connector, etc.

In view of the above, a need exists for an apparatus that facilitates rotation of a connector fitting that may be easily secured to and removed from the fitting, e.g., via a snap or press fit. There is also a need for an apparatus that may be selectively secured to fittings that are connected to other fittings, tubing and the like, without disconnection, and that do not require any modifications to the fittings themselves. Embodiments of the invention fulfill these needs and more, as discussed in greater detail below.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of the possible embodiments. Indeed, the disclosure may encompass a variety of forms that may be similar to or different from the embodiments set forth below.

According to an aspect of the invention, an apparatus for facilitating rotation of a fitting includes a body having an exterior portion and an interior portion, the exterior portion having an opening configured to allow the body to be placed onto the fitting such that the fitting is received in the interior portion. The apparatus further includes a plurality of engagement surfaces located in the interior portion, the plurality of engagement surfaces configured to matingly engage an exterior of the fitting, and at least two ergonomic tabs formed on the exterior portion of the body, the ergonomic tabs configured to be gripped by a user to facilitate rotation of the fitting. The apparatus further includes at least one stop located on the body, the at least one stop configured to inhibit axial movement of the body relative to the fitting when secured thereto. In use, the body may be selectively placed on a fitting to facilitate rotation of the fitting by a user.

In an embodiment, the body is manufactured from a resilient polymeric material and may be snap fit onto the fitting.

In an embodiment, the opening in the body may be defined by two flexible wings.

In an embodiment, the two ergonomic tabs may be located on opposite sides of the exterior portion of the body and are configured to engage a user's thumb and forefinger.

In an embodiment, the interior portion of the body may be substantially circular, and the plurality of engagement surfaces includes a plurality of circumferentially arranged recesses formed in the interior portion, the plurality of circumferentially arranged recesses being configured to matingly engage a plurality of circumferential ribs on the exterior of the fitting.

In an embodiment, the plurality of circumferentially arranged recesses may include at least five recesses.

In an embodiment, the interior portion of the body is substantially circular, and the plurality of engagement surfaces includes two recesses formed in the interior portion, each of the two recesses being substantially aligned with one of the two ergonomic tabs, wherein the two recesses are configured to matingly engage two ribs on the exterior of the fitting.

In an embodiment, the at least one stop may include two substantially arcuate stops that extend outward from the exterior portion of the body, the two substantially arcuate stops being configured to fit over a flange portion of the fitting to inhibit axial movement of the body relative to the fitting when secured thereto.

In an embodiment, the interior portion of the body is substantially circular, and the plurality of engagement surfaces may include three recesses formed in the interior portion, wherein each of the three recesses is offset by about 90 degrees from an adjacent recess and two of the recesses are substantially aligned with the two ergonomic tabs, wherein the three recesses are configured to matingly engage three ribs on the exterior of the fitting.

In an embodiment, the interior portion of the body is substantially circular, and the plurality of engagement surfaces may include a plurality of teeth formed in the interior portion, the plurality of teeth extending circumferentially about the interior portion, wherein the plurality of teeth are configured to matingly engage corresponding teeth on the exterior of the fitting.

In an embodiment, the fitting may be a coaxial connector, the interior portion may be substantially hexagonal, and the plurality of engagement surfaces are at least five flat engagement surfaces, each of which being at an approximate 120-degree angle from an adjacent engagement surface, wherein the five flat engagement surfaces are configured to matingly engage with the exterior of the coaxial connector.

In an embodiment, a surface adjacent to the opening includes at least one filleted edge portion to facilitate placement of the body onto the fitting such that the fitting is received in the interior portion.

In an embodiment, the at least one stop has a filleted edge portion to facilitate placement and/or removal of the body onto or from the fitting.

According to another aspect of the invention, a system for facilitating movement of a first fitting relative to a second fitting includes a first body having an exterior portion and an interior portion, the exterior portion having an opening configured to allow the first body to be placed onto the first fitting such that the first fitting is received in the interior portion and a plurality of engagement surfaces located on the interior portion, the plurality of engagement surfaces configured to matingly engage an exterior of the first fitting. The first body further includes at least two ergonomic tabs to facilitate rotation of the first fitting and at least one stop located on the first body, the at least one stop configured to inhibit axial movement of the first body relative to the first fitting. The system further includes a second body having an exterior portion and an interior portion, the exterior portion having an opening configured to allow the second body to be placed onto the second fitting such that the second fitting is received in the interior portion. A plurality of engagement surfaces located on the interior portion, the plurality of engagement surfaces configured to matingly engage an exterior of the second fitting. The second body including at least two ergonomic tabs configured to be gripped by a user to facilitate rotation of the second fitting and at least one stop located on the second body, the at least one stop configured to inhibit axial movement of the second body relative to the second fitting. In use, the first body and second body may be used to manipulate the first and/or second fitting relative to the other of the first and/or second fitting.

In an embodiment, the first fitting and the second fitting are luer connectors.

In an embodiment, the first body and the second body are manufactured from a resilient polymeric material and may be snap fit onto the first and second fittings.

In an embodiment, the plurality of engagement surfaces of the first body may be structurally different from the plurality of engagement surfaces of the second body.

In an embodiment, the first body may be a first color and the second body is a second color that is different from the first color.

In an embodiment, the plurality of engagement surfaces of the first body may include a plurality of circumferentially arranged recesses formed in the interior portion, the plurality of circumferentially arranged recesses being configured to matingly engage a plurality of circumferential ribs on the exterior of the first fitting.

In an embodiment, the plurality of engagement surfaces of the second body may include two recesses formed in the interior portion, each of the two recesses being substantially aligned with one of the two ergonomic tabs, wherein the two recesses are configured to matingly engage two ribs on the exterior of the second fitting.

Features which are described in the context of separate aspects and embodiments of the invention may be used together and/or be interchangeable. Similarly, features described in the context of a single embodiment may also be provided separately or in any suitable sub-combination.

### BRIEF DESCRIPTION OF THE FIGURES

The present invention will be better understood from reading the following description of non-limiting embodiments, with reference to the attached drawings, wherein below:

FIG. 1 is an isometric view of an apparatus for facilitating rotation of a barrel-style luer fitting according to an embodiment of the invention;

FIG. 2 is a front view of the apparatus of FIG. 1;

FIG. 3 is a side view of the apparatus of FIG. 1;

FIG. 4A is a top view of the apparatus of FIG. 1;

FIG. 4B is an enlarged view of portion A of FIG. 4A;

FIG. 5 is a front view of the apparatus of FIG. 1 being attached to a barrel-style luer fitting;

FIG. 6 is another front view of the apparatus of FIG. 1 being attached to a barrel-style luer fitting;

FIG. 7 is another front view of the apparatus of FIG. 1 being attached to a barrel-style luer fitting;

FIG. 8 is an isometric view of the apparatus of FIG. 1 being attached to a barrel-style luer fitting;

FIG. 9 is another isometric view of the apparatus of FIG. 1 being attached to a barrel-style luer fitting;

FIG. 10 is yet another isometric view of the apparatus of FIG. 1 being attached to a barrel-style luer fitting;

FIG. 11 is an isometric view of an apparatus for facilitating rotation of a luer lock fitting having wings and a collar according to another embodiment of the invention;

FIG. 12 is a front view of the apparatus of FIG. 11;

FIG. 13 is a side view of the apparatus of FIG. 11;

FIG. 14A is a top view of the apparatus of FIG. 11;

FIG. 14B is an enlarged view of portion A of FIG. 11;

FIG. 15 is an isometric view of the apparatus of FIG. 11 being attached to a luer fitting having wings and a collar;

FIG. 16 is another isometric view of the apparatus of FIG. 11 being attached to a luer fitting having wings and a collar;

FIG. 17 is yet another isometric view of the apparatus of FIG. 11 being attached to a luer fitting having wings and a collar;

FIG. 18 is another isometric view of the apparatus of FIG. 11 being attached to a luer fitting having wings and a collar;

FIG. 19 is an isometric view of an assembly of two luer lock fittings, as commonly found in medical applications, to which the apparatus of FIGS. 1 and 11 have been attached.

FIG. 20 is an isometric view of the assembly of luer lock fittings of FIG. 19 without the apparatus attached;

FIG. 21 is an isometric view of an apparatus for facilitating rotation of a luer fitting having a hexagonal barrel with four ridges according to another embodiment of the invention;

FIG. 22 is a front view of the apparatus of FIG. 21;

FIG. 23 is a side view of the apparatus of FIG. 21;

FIG. 24 is a top view of the apparatus of FIG. 21;

FIG. 25 is an isometric view of an apparatus for facilitating rotation of a luer fitting having a serrated cylinder according to yet another embodiment of the invention;

FIG. 26 is a front view of the apparatus of FIG. 25;

FIG. 27 is a side view of the apparatus of FIG. 25;

FIG. 28 is a top view of the apparatus of FIG. 25;

FIG. 29A is an isometric view of the apparatus of FIG. 1;

FIG. 29B is an isometric view of the luer fitting to which the apparatus of FIG. 29A is configured to be removably attached to;

FIG. 30A is an isometric view of the apparatus of FIG. 11;

FIG. 30B is an isometric view of the luer fitting to which the apparatus of FIG. 30A is configured to be removably attached to;

FIG. 31A is an isometric view of the apparatus of FIG. 21;

FIG. 31B is an isometric view of the luer fitting to which the apparatus of FIG. 31A is configured to be removably attached to;

FIG. 32A is an isometric view of the apparatus of FIG. 25;

FIG. 32B is an isometric view of the luer fitting to which the apparatus of FIG. 32A is configured to be removably attached to;

FIG. 33 is an isometric view of an apparatus for facilitating rotation of a coaxial fitting according to another embodiment of the invention.

FIG. 34 is an isometric view of a coaxial fitting configured for use with the apparatus of FIG. 33;

FIG. 35 is an isometric view of the apparatus of FIG. 33 attached to the fitting of FIG. 33;

FIG. 36A is an isometric view of an apparatus for facilitating rotation of a fitting according to another embodiment of the invention.

FIG. 36B is an isometric view of the fitting to which the apparatus of FIG. 36A is configured to be removably attached to;

FIG. 37A is an isometric view of an apparatus for facilitating rotation of a fitting according to yet another embodiment of the invention.

FIG. 37B is an isometric view of the fitting to which the apparatus of FIG. 37A is configured to be removably attached to;

FIG. 38A is an isometric view of an apparatus for facilitating rotation of a fitting according to another embodiment of the invention;

FIG. 38B is an isometric view of the fitting to which the apparatus of FIG. 38A is configured to be removably attached to.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts.

As used herein, the term “flexible” refers to a structure or material that is pliable, or capable of being bent without breaking, and may also refer to a material that is compressible or expandable. In particular, flexible materials contemplated for use in embodiments of the invention provide a resiliency sufficient to facilitate use in a snap or press fit application and/or be sufficient to allow for effective rotation of a fitting.

A “fitting,” as the term is used herein, refers to a connector or adaptor, including, but not limited to, rotatable connectors such as luer type connectors, e.g., luer locks, and coaxial connectors. Although embodiments are described for use with specific fittings (e.g., specific luer connectors), and may be particularly suited for a medical context, they are not so limited and embodiments may be suitable for rotating and/or manipulating a wide variety of fittings used with a range of tubing, hoses, and cables. Likewise, embodiments are not limited a type of user or use setting/industry and embodiments may be generally suitable for use where an case of rotation or manipulation of a fitting is desirable.

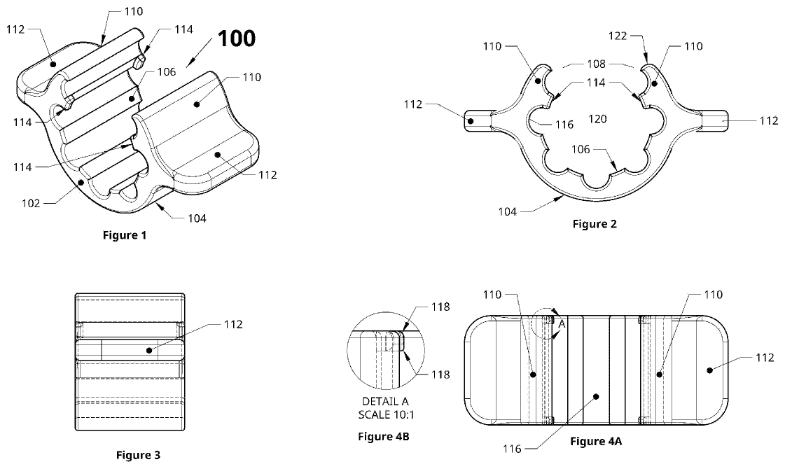

FIGS. 1, 2, 3, 4A, and 4B depict an apparatus 100 for facilitating rotation of a fitting according to an embodiment of the present invention. As shown, apparatus 100 includes a body 102 having an exterior portion 104 and an interior portion 106. The exterior portion 104 has an opening 108 that, in an embodiment, is defined by two flexible wings 110.

As shown, the interior portion 106 of the body 102 is substantially circular in shape and defines an open interior 120 which is sized and shaped to accommodate a fitting. The interior portion 106 features a plurality of engagement surfaces that are circumferentially arranged and formed in the interior portion 106. In this embodiment, the engagement surfaces are and/or include a plurality of circumferentially arranged recesses 116 formed in the interior portion 106. As discussed in greater detail below, the plurality of circumferentially arranged recesses 116 are configured (e.g., sized and shaped) to matingly engage a plurality of circumferential ribs 162 on an exterior 168 of a fitting 160, when the body 102 is placed on the fitting 160 (FIGS. 5-10). In the depicted embodiment, there are five recesses 116, though there may be greater or fewer depending on the number of circumferential ribs 162 on the fitting 160.

The exterior portion 104 features at least two ergonomic tabs 112 that are configured to be gripped by a user to facilitate rotation of a fitting. The ergonomic tabs 112 are configured to be manipulated by via a user's thumb and forefinger. As depicted, in an embodiment, the ergonomic tabs 112 are on opposite sides of the body 102. As will be appreciated, the ergonomic tabs 112 provide increased leverage beyond that of the fitting itself.

The body 102 further includes at least one stop 114. In the present embodiment, four stops 114 are employed, though the invention is not so limited. The stops 114 are configured to inhibit lengthwise or axial movement (along or parallel to axis A) of the body 102 relative to the fitting 160 (FIGS. 5-10) when secured thereto. The stops 114 may have a variety of shapes and sizes. In the depicted embodiment, the stops 114 are protrusions/tabs that extend radially into the open interior 120 of the body 102.

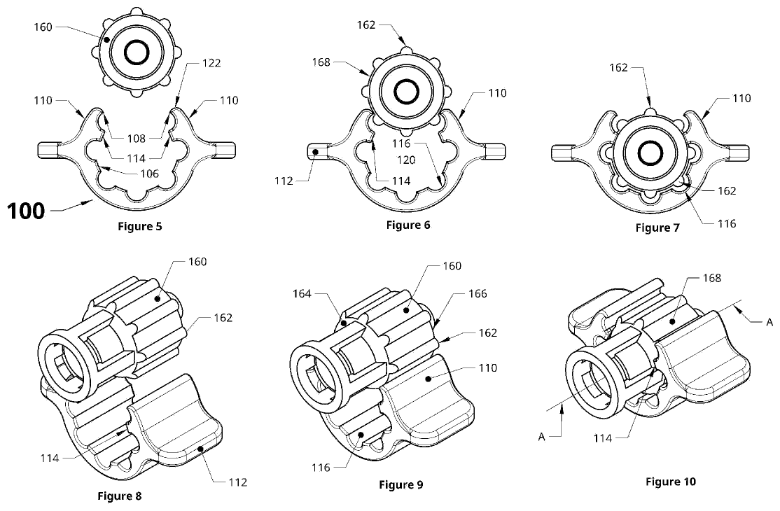

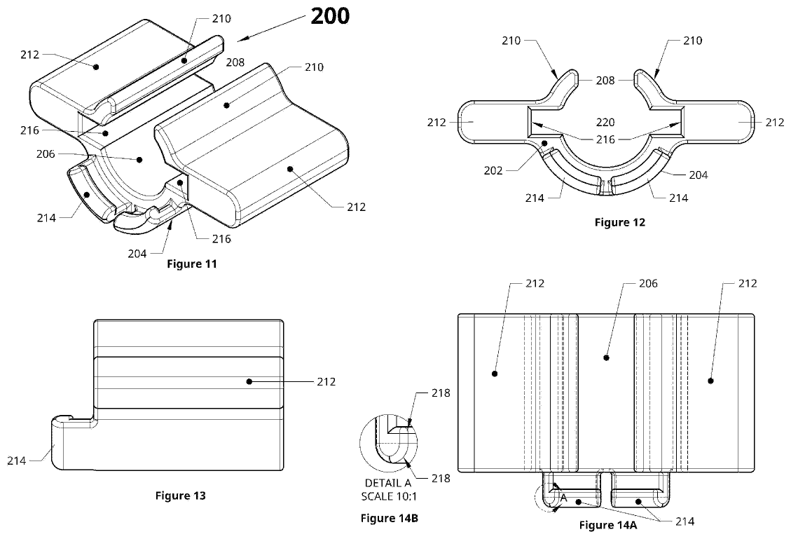

Referring now to FIGS. 4A-5, in certain embodiments, the stops 114 may have a filleted edge portion 118 to facilitate placement and/or removal of the body 102 from the fitting 160. In the depicted embodiment, the stops 114 have two filleted edge portions 118 which facilitate the attachment (and removal) of the body 102 to a fitting 160 by sliding the fitting 160 laterally into the open interior of the body 102. The filleted edge portions reduce potential abrasion on tubing operatively connected to the fitting.

In addition to sliding a fitting 160 into the body 102 laterally, a fitting 160 may be snap or press fit into the open interior 120 through the opening 108. This process is depicted in FIGS. 5-10. As shown in FIG. 6 the fitting 160 is urged between the wings 110 which widens/enlarges the opening 108 permitting the passage of the fitting so that it is received in the open interior 120. Once the fitting 160 is in the open interior 120, the circumferential ribs 162 are brought in mating engagement with the circumferentially arranged recesses 116. Once seated, the stops 114 of the body 102 resiliently contact a leading edge 164 and a trailing edge 166 of the exterior 168 of the fitting 160 preventing relative movement of the body 102.

In certain embodiments, a surface that is adjacent to the opening 108 may have at least one filleted edge portion 122. In embodiments, the filleted edge portion 122 is located on a distal end of a wing 110. As will be appreciated, the filleted edge portion 122 facilitates placement of the body 102 onto the fitting 160 through the opening 108.

In embodiments, the body 102 is manufactured from a flexible polymeric material, such as a plastic, that allows the body 102 to be selectively placed on a fitting as described herein. The body 102 should have sufficient rigidity/resiliency to allow for a snap fit onto a fitting 160 as described herein. As will be appreciated, the amount of flex and holding power of the body 102 may be varied based on the fitting, use, and other considerations. The body 102 may be manufactured via a variety of processes including, but not limited to, additive manufacturing or injection molding.

It is envisioned that a user may utilize the ergonomic tabs to rotate a fitting and also remove the body 102 from a fitting with one hand and/or with minimal effort. The flexibility of the body 102 facilitates this by allowing the opening 108 to widen and the stops 114 to flex so the body may be removed. In some applications, the apparatus can be produced to allow for a limited slip while rotating to tighten, reducing occurrences of over-tightening.

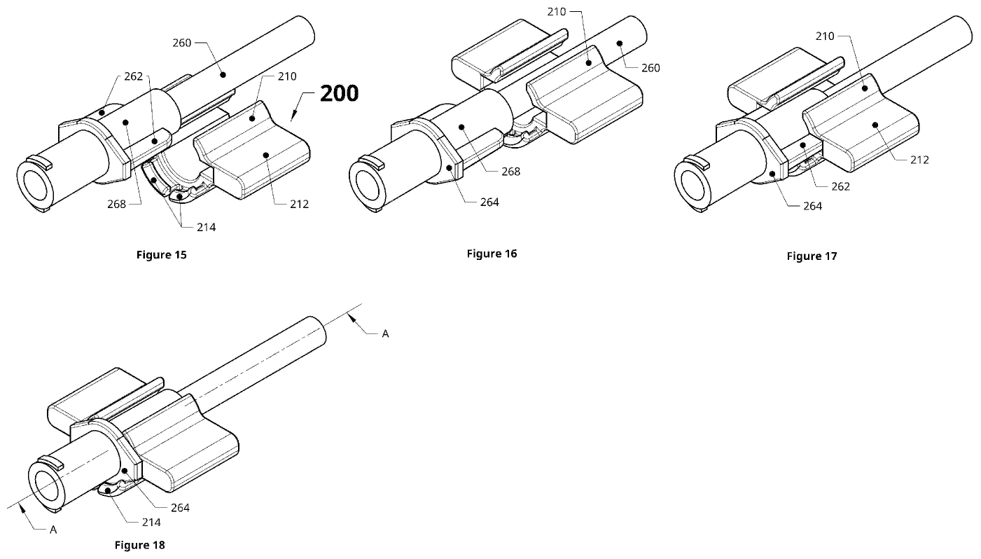

Turning now to FIGS. 11, 12, 13, 14A and 14B, another embodiment of the invention is depicted. In this embodiment, the apparatus 200 has a body 202 having an exterior portion 204 and an interior portion 206. The exterior portion 204 has an opening 208 that, in an embodiment, is defined by two flexible wings 210. The exterior portion 204 also includes ergonomic tabs 212 that facilitate rotation of a fitting.

As illustrated, the interior portion 206 of the body 202 is substantially circular in shape and defines an open interior 220 which is sized and shaped to accommodate a fitting 260. The interior portion 206 features a plurality of engagement surfaces that are and/or include, in the depicted embodiment, two recesses 216 formed in the interior portion 206, each of the two recesses 216 being substantially aligned with one of the at least two ergonomic tabs 212, wherein the two recesses are configured to matingly engage two ribs 262 on the exterior 268 of the fitting 260 (FIG. 15).

In the depicted embodiment, the at least one stop includes two substantially arcuate stops 214 that extend outward from the exterior portion. The two stops have filleted edge portions 218 that facilitate laterally sliding a fitting 260 into (and out of) the open interior 220.

Referring to FIGS. 15-18, in use, a fitting 260 may be placed into the opening 208 and then urged backward onto a collar or flange portion 264 of the fitting 260 snaps over the stops 214 and the two wings or ribs 262 on the exterior 268 of the fitting 260 slot into the two recesses 216.

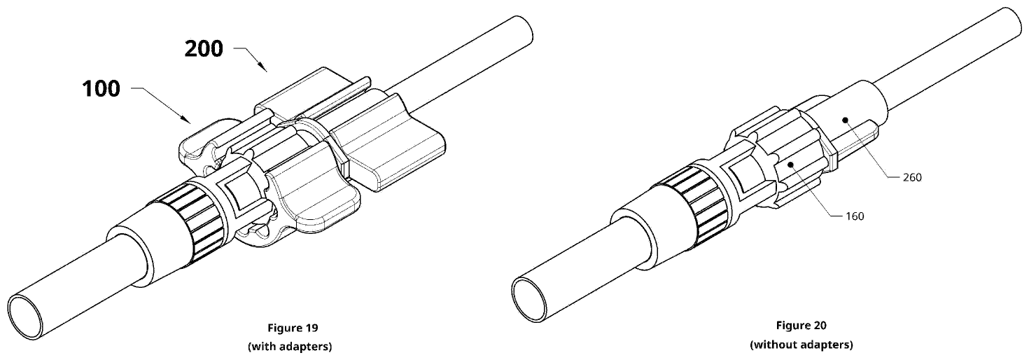

Referring now to FIGS. 19 and 20, a common luer lock fitting assembly is shown. The assembly includes a first fitting 160 connected to a second fitting 260. As shown, fittings have different engagement features on their exteriors. FIG. 19 depicts these fittings 160, 260 with apparatus for facilitating rotation of the fittings according to an embodiment of the invention. In particular, the fitting 160 has apparatus 100 secured to it, and the second fitting 260 has apparatus 200 secured thereto. In this regard, embodiments contemplate a system in which two or more apparatus, e.g., apparatus 100, 200 are utilized together.

In embodiments, the apparatus 100, 200 may be secured to the fittings 160, 260 without disconnecting them. As will be appreciated, this provides a significant ease of use. In other embodiments, the apparatus 100, 200 may be color coded. That is, body 102, 202 may be in a color that represents or is indicative of a role, function, or level of importance. Different color apparatus may be used in a context where fittings are interconnected and adjacent to visually distinguish them and guide a user. In embodiments, the first body is a first color and the second body is a second color that is different from the first color. In other embodiments, the colors may be the same. As will be appreciated, in certain environments, it may be convenient to color match the first and second bodies, if, for example, they are used on adjacent fittings on the same set of dialysis lines.

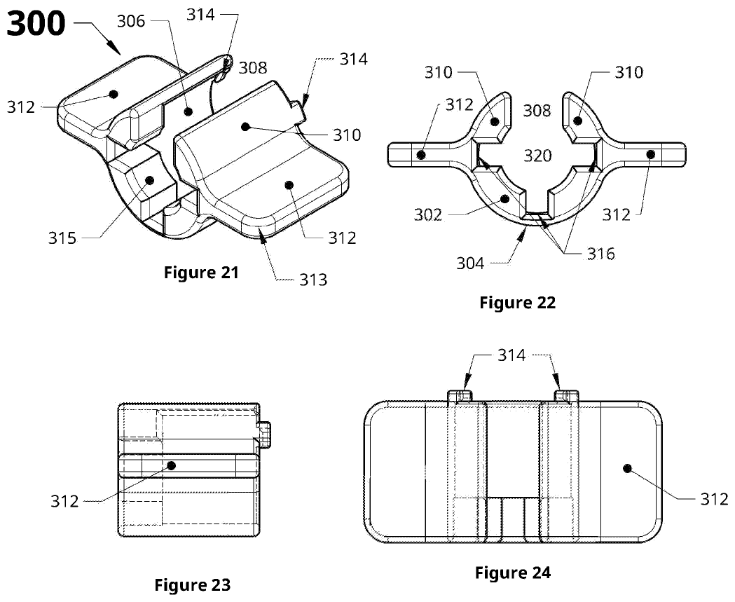

Turning now to FIGS. 21-24 an apparatus for facilitating rotating of a fitting according to yet another embodiment is shown. In this embodiment, the apparatus 300 has a body 302 having an exterior portion 304 and an interior portion 306. As with the prior embodiments, the exterior portion 304 has an opening 308 that is defined by two flexible wings 310. The exterior portion 304 also includes ergonomic tabs 312 that facilitate rotation.

As depicted, the interior portion 306 of the body 302 includes an open interior 320 which is sized and shaped to accommodate a fitting 360 (FIG. 31B). In particular, the interior portion 306 features a plurality of engagement surfaces 315 that, in the illustrated embodiment, are and/or include three recesses 316 formed in the interior portion 306, wherein each of the three recesses 316 is offset by about 90 degrees from an adjacent recess, and two of the three recesses are substantially aligned with the at least two ergonomic tabs 312, wherein the three recesses are configured to matingly engage three ribs 362 on the exterior of the fitting 360. This embodiment also includes stops 314 which may be filleted surfaces.

In embodiments, the body 302 may include anti-snag fillets 313 which prevent the apparatus from catching and damaging adjacent material (FIG. 21).

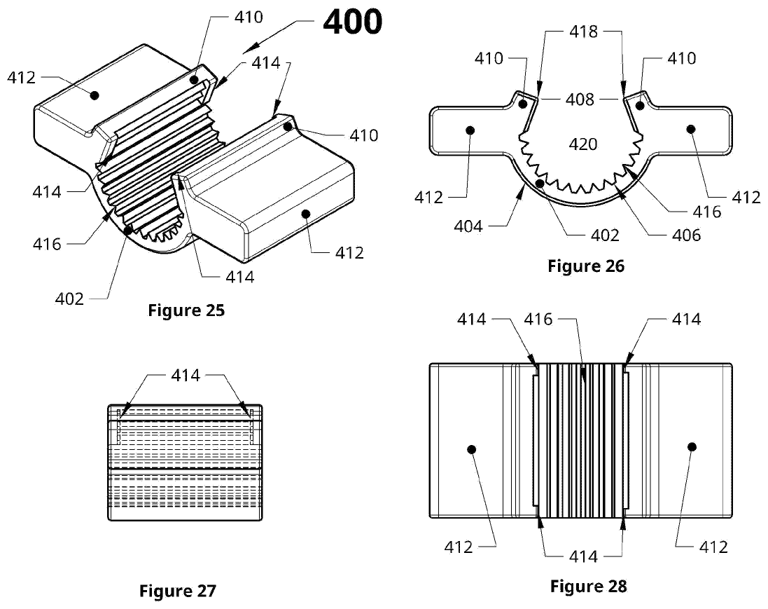

As shown in FIGS. 25-28, an additional embodiment is depicted. Here, the apparatus 400 as a body 402 having an exterior portion 404 and an interior portion 406. The exterior portion 404 has an opening 408 that, in an embodiment, is defined by two flexible wings 410. The exterior portion 204 also includes ergonomic tabs 412.

As illustrated, the interior portion 406 of the body 402 is substantially circular in shape and defines an open interior 420 which is sized and shaped to accommodate a fitting 460 (FIG. 32B). The interior portion 406 features a plurality of engagement surfaces that are and/or include a plurality of teeth 416 formed in the interior portion 406, the plurality of teeth 416 extend circumferentially about the interior portion and are configured to matingly engage corresponding serrations or teeth 462 on the exterior of the fitting 470.

In the depicted embodiment, the at least one stop 414 includes four stops 414. The four stops 414 may have filleted edge portions 418 that facilitate laterally sliding a fitting 460 into (and out of) the open interior 420. The wings 410 may also include a surface with a filleted edge portion to facilitate placement of a fitting 460 into the body through the opening 408.

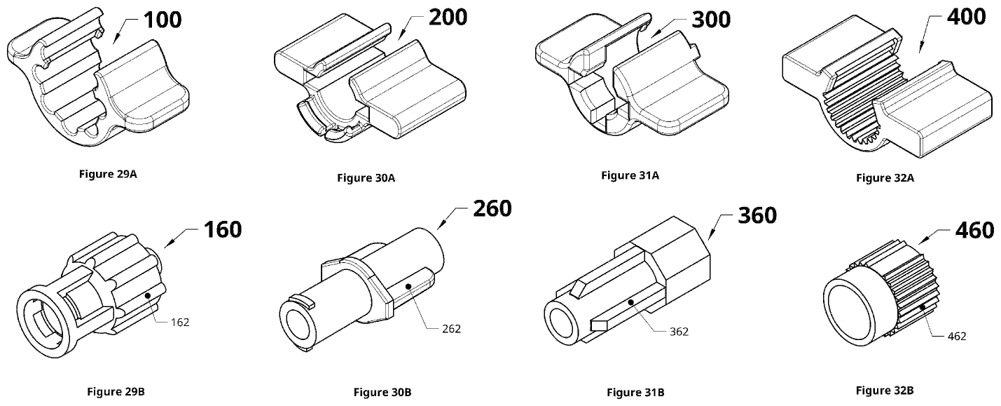

Referring now to FIGS. 29A, 29B, 30A, 30B, 31A, 31B, 32A and 32B, embodiments of the apparatus 100, 200, 300, 400 may be configured for use with common luer connectors, 160 260, 360, 460. Of course, as mentioned, the invention is not limited to a specific connector type or shape and embodiments may be used with a wide variety of fittings.

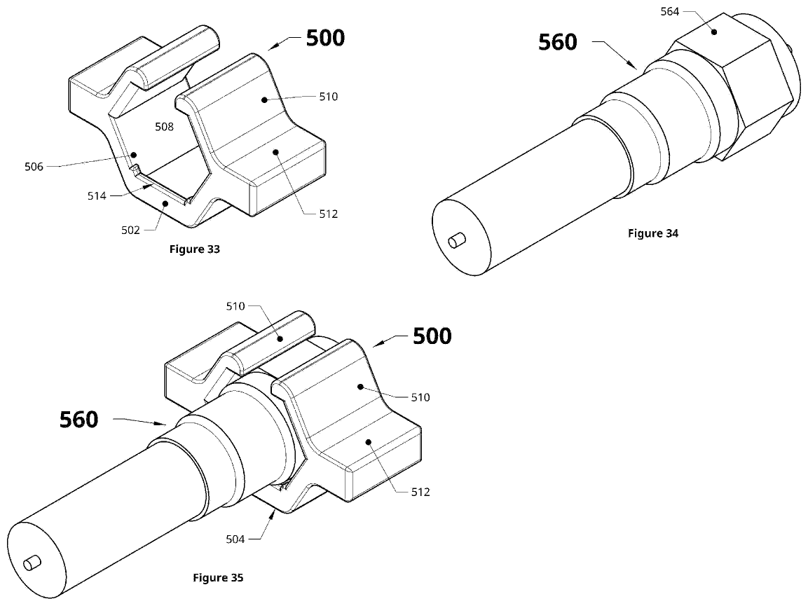

Turning to FIGS. 33-35, an embodiment of the inventive apparatus 500 may be configured for use with coaxial connectors 560. In this embodiment, the body 502 includes an exterior portion 504 and an interior portion 506, the exterior portion having ergonomic tabs 512 and wings 510 similar to the aforementioned embodiments. The body 502 further includes at least one stop 514 which in this instance is two stops 514 on either side of the open interior 508.

As shown, the interior portion 506 is substantially hexagonal, and the plurality of engagement surfaces 516 are and/or include at least five flat engagement surfaces 516, each of which being at an approximate 120-degree angle from an adjacent engagement surface, wherein the at least five flat engagement surfaces 516 are configured to matingly engage with an exterior of a hexagonal fitting nut 564 of the coaxial connector 560 to facilitate rotation of the nut 564.

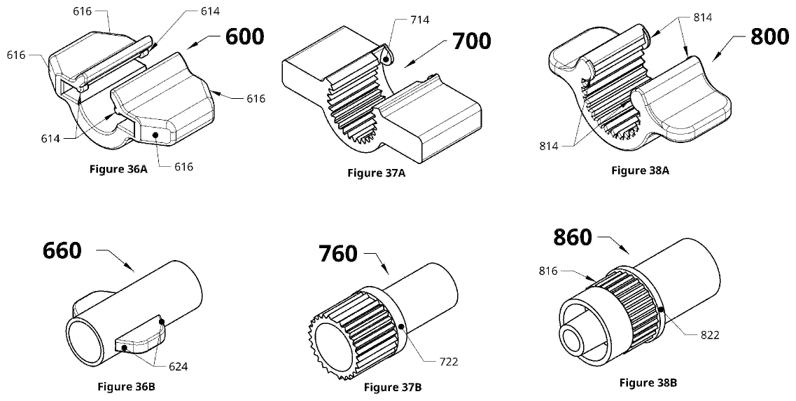

Referring now to FIGS. 36A, 36B, 37A, 37B, 38A and 38B, several alternative embodiments of the inventive apparatus 600, 700, 800 and their corresponding fittings 660, 760, 860 are depicted. Apparatus 600, while similar to apparatus 200, should be clearly distinguishable to the user as it is used in conjunction with fitting 660 which features a smaller diameter and wings with chamfered edges 624 and thus the design differs from apparatus 200 in the shape of the ergonomic tabs by including chamfered edges 616. It also utilizes four stops 614 to snap into place around fitting 660. Apparatus 700 features a wide stop 714 to accommodate wide collar 722 on corresponding fitting 760. Apparatus 800 features four stops 814 that hold the apparatus in place around the raised teeth 816 and collar 822 of fitting 860.

As used herein, an element or step recited in the singular and proceeded with the word “a” or “an” should be understood as not excluding plural of said elements or steps, unless such exclusion is explicitly stated. Furthermore, references to “an embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

While the dimensions and types of materials described herein are intended to define the parameters of the invention, they are by no means limiting and are exemplary embodiments. Many other embodiments will be apparent to those of skill in the art upon reviewing the above description.

The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

Moreover, in the following claims, terms such as “first,” “second,” “upper,” “lower,” “bottom,” “top,” etc. are used merely as labels, and are not intended to impose numerical or positional requirements on their objects. Further, the limitations of the following claims are not written in means-plus-function format and are not intended to be interpreted as such, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal language of the claims.

1. An apparatus for facilitating rotation of a fitting, the apparatus comprising:
a body having an exterior portion and an interior portion, the exterior portion having an opening configured to allow the body to be placed onto the fitting such that the fitting is received in the interior portion;
a plurality of engagement surfaces located in the interior portion, the plurality of engagement surfaces configured to matingly engage an exterior of the fitting;
at least two ergonomic tabs formed on the exterior portion of the body, the at least two ergonomic tabs configured to be gripped by a user to facilitate rotation of the fitting; and
at least one stop located on the body, the at least one stop configured to inhibit axial movement of the body relative to the fitting when secured thereto;
wherein in use the body may be selectively placed on a fitting to facilitate rotation of the fitting by a user.

2. The apparatus of claim 1 wherein the body is manufactured from a resilient polymeric material and may be snap or press fit onto the fitting.

3. The apparatus of claim 1 wherein the opening in the body is defined by two flexible wings.

4. The apparatus of claim 1 wherein the at least two ergonomic tabs are located on opposite sides of the exterior portion of the body and are configured to engage a user's thumb and forefinger.

5. The apparatus of claim 1 wherein the interior portion of the body is substantially circular, and the plurality of engagement surfaces includes a plurality of circumferentially arranged recesses formed in the interior portion, the plurality of circumferentially arranged recesses being configured to matingly engage a plurality of circumferential ribs on the exterior of the fitting.

6. The apparatus of claim 5 wherein the plurality of circumferentially arranged recesses include at least five recesses.

7. The apparatus of claim 1 wherein the interior portion of the body is substantially circular, and the plurality of engagement surfaces includes two recesses formed in the interior portion, each of the two recesses being substantially aligned with one of the at least two ergonomic tabs, wherein the two recesses are configured to matingly engage two ribs on the exterior of the fitting.

8. The apparatus of claim 7 wherein the at least one stop includes two substantially arcuate stops that extend outward from the exterior portion of the body, the two substantially arcuate stops being configured to fit over a flange portion of the fitting to inhibit axial movement of the body relative to the fitting when secured thereto.

9. The apparatus of claim 1 wherein the interior portion of the body is substantially circular, and the plurality of engagement surfaces includes three recesses formed in the interior portion, wherein each of the three recesses is offset by about 90 degrees from an adjacent recess, and two of the three recesses are substantially aligned with the at least two ergonomic tabs, wherein the three recesses are configured to matingly engage three ribs on the exterior of the fitting.

10. The apparatus of claim 1 wherein the interior portion of the body is substantially circular, and the plurality of engagement surfaces includes a plurality of teeth formed in the interior portion, the plurality of teeth extending circumferentially about the interior portion, wherein the plurality of teeth are configured to matingly engage corresponding teeth on the exterior of the fitting.

11. The apparatus of claim 1 wherein the fitting is a coaxial fitting, the interior portion is substantially hexagonal, and the plurality of engagement surfaces are at least five flat engagement surfaces, each of which being at an approximate 120-degree angle from an adjacent engagement surface, wherein the at least five flat engagement surfaces are configured to matingly engage with the exterior of the coaxial fitting.

12. The apparatus of claim 1 wherein a surface adjacent to the opening includes at least one filleted edge portion to facilitate placement of the body onto the fitting such that the fitting is received in the interior portion.

13. The apparatus of claim 1 wherein the at least one stop has a filleted edge portion to facilitate placement and/or removal of the body onto or from the fitting.

14. A system for facilitating movement of a first fitting relative to a second fitting, the system comprising:
a first body having an exterior portion and an interior portion, the exterior portion having an opening configured to allow the first body to be placed onto the first fitting such that the first fitting is received in the interior portion;
a plurality of engagement surfaces located on the interior portion, the plurality of engagement surfaces configured to matingly engage an exterior of the first fitting;
at least two ergonomic tabs to facilitate rotation of the first fitting;
at least one stop located on the first body, the at least one stop configured to inhibit axial movement of the first body relative to the first fitting;
a second body having an exterior portion and an interior portion, the exterior portion having an opening configured to allow the second body to be placed onto the second fitting such that the second fitting is received in the interior portion;
a plurality of engagement surfaces located on the interior portion, the plurality of engagement surfaces configured to matingly engage an exterior of the second fitting;
at least two ergonomic tabs configured to be gripped by a user to facilitate rotation of the second fitting; and
at least one stop located on the second body, the at least one stop configured to inhibit axial movement of the second body relative to the second fitting;
wherein, in use, the first body and second body may be used to manipulate the first fitting and/or second fitting relative to one another.

15. The system of claim 14 wherein the first fitting and the second fitting are luer connector fittings.

16. The system of claim 14 wherein the first body and the second body are manufactured from a resilient polymeric material and may be snap or press fit onto the first fitting and/or second fitting.

17. The system of claim 14 wherein the plurality of engagement surfaces of the first body are structurally different from the plurality of engagement surfaces of the second body.

18. The system of claim 14 wherein the first body is a first color and the second body is a second color that is different from the first color.

19. The system of claim 14 wherein the plurality of engagement surfaces of the first body includes a plurality of circumferentially arranged recesses formed in the interior portion, the plurality of circumferentially arranged recesses being configured to matingly engage a plurality of circumferential ribs on the exterior of the first fitting.

20. The system of claim 14 wherein the plurality of engagement surfaces of the second body includes two recesses formed in the interior portion, each of the two recesses being substantially aligned with one of the at least two ergonomic tabs, wherein the two recesses are configured to matingly engage two ribs on the exterior of the second fitting.
